(19) United States
(12) Patent Application Publication
(10) Pub. No.: US 2012/0069787 A1
(43) Pub. Date: Mar. 22, 2012

(54) COMMUNICATION DEVICE AND COMMUNICATION METHOD THEREOF

(75) Inventor: Nobuhiro TAMURA, Nagoya-shi (JP)

(73) Assignee: Buffalo Inc., Nagoya-shi (JP)

(21) Appl. No.: 13/235,423

(22) Filed: Sep. 18, 2011

(30) Foreign Application Priority Data
Sep. 21, 2010 (JP) 2010-210650

(51) Int. Cl. H04W 84/02

(52) U.S. Cl. 370/315

(57) ABSTRACT

A communication device includes a wireless LAN interface that can communicate with a wireless device other than the communication device, and a wired LAN interface having a plurality of ports, and relays a communication between an electronic device connected to each of the plurality of ports and the wireless device. When an electronic device is connected to a specific port set beforehand among the plurality of ports, the communication device obtains the MAC address of the electronic device, uses the obtained MAC address as the local MAC address, and communicates with the wireless device.

### CROSS-REFERENCE TO RELATED APPLICATION

This application claims the benefit of Japanese Patent Application No. 2010-210650 filed on Sep. 21, 2010, the entire disclosure of which is herein incorporated by reference.

### BACKGROUND OF THE INVENTION

1. Field of the Invention

The present invention relates to a communication device and a communication method thereof. Particularly, the present invention relates to a communication device that has a wireless LAN interface and a wired LAN interface with a plurality of ports, and a communication method thereof.

2. Description of the Related Art

A so-called Ethernet (registered trademark) converter is known as an example station (hereinafter, referred to as a “station”) that is a non-access-point client in a wireless LAN (Local Area Network). The Ethernet converter has a station interface and a wired LAN interface, performs format conversion based on communication standards of both interfaces, and relays communication packets. When a wired device like a terminal device or digital home electronics with a wired LAN port is connected to the wired LAN port of the Ethernet converter through a wired LAN cable, the wired device can communicate with a wireless device other than the wired device via the Ethernet converter.

There is known such an Ethernet converter having a plurality of wired ports. When receiving communication packets from a wired device connected to a wired port, the Ethernet converter with the plurality of wired ports performs format conversion, and transfers the received packets to the wireless device. At this time, the Ethernet converter adds, as an originator address, a local MAC (Media Access Control) address to the communication packets transferred to the wireless device. Conversely, when receiving communication packets from the wireless device, the Ethernet converter checks a destination IP address included in the communication packets with an address table associating the MAC address of the connected wired device with an IP (Internet Protocol) address, and transfers the communication packets to the wired device having the destination IP address.

On the other hand, a protocol (hereinafter, referred to as an operation instructing protocol) is developed which is capable of, based on information on a MAC address included in the body of communication packets, instructing a predetermined operation to an electronic device which receives the communication packets and which has that MAC address. An example technology using such a protocol is WOL (Wake-On-LAN) (see, for example, JP 2004-303078 A). The WOL is a function of remotely turning on the power of a network device over a network. According to the WOL, such a remote control is performed using communication packets that are called magic packets. The magic packets include a synchronization sequence that is “FF-FF-FF-FF-FF-FF” and data following to that sequence and repeating the MAC address of a device subjected to the power-on operation sixteen times in an arbitrary region of the body, and are transmitted in a broadcast manner. When the MAC address repeated by sixteen times is not for a local device, such a local device receiving the magic packets ignores the packets, and when the repeated MAC address is for the local device, such a local device is activated from a power-saving condition (e.g., a sleep condition of consuming substantially no energy or a suspended condition in which the power is turned off), and transitions to a normal operation condition.

When the Ethernet converter having the plurality of wired ports receives magic packets through a wireless client interface, since the destination IP address (a broadcast address) of the magic packets is not recorded in the above-explained table, the Ethernet converter discards the magic packets. As a result, the device which is connected to the wired port and which is subjected to the power-on operation is unable to receive the magic packets, and the WOL cannot be established. Even if a configuration is employed which transfers the magic packets to all wired ports, the MAC address repeated by sixteen times and included in the magic packets is the MAC address of the Ethernet converter, so that the device which is subjected to the power-on operation and which receives the magic packets ignores the magic packets. This is because the Ethernet converter communicates with a wireless device using the local MAC address, and such wireless device recognizes the MAC address of the Ethernet converter as the MAC address of the device subjected to the power-on operation.

As explained above, according to the conventional Ethernet converters, it is difficult to appropriately establish the WOL. Such a problem is not limited to the case in which the WOL is established but is common to a case in which a wired device connected to an Ethernet converter using the operation instruction protocol is remotely controlled.

It is an object of the present invention to realize an appropriate remote control through a communication device having a wireless LAN interface and a wired LAN interface with a plurality of ports using a protocol configured to be capable of instructing a predetermined operation to an electronic device having an MAC address of receiving communication packets based on information on that MAC address included in the body of the communication packets.

### SUMMARY OF THE INVENTION

The present invention provides a communication device that includes: a wireless LAN interface that can communicate with a wireless device other than the communication device; a wired LAN interface having a plurality of ports; a relay unit that relays a communication between an electronic device connected to the plurality of ports in a communicatable manner and the wireless device through the wireless LAN interface and the wired LAN interface; and an obtaining unit that obtains, when the electronic device is connected to a specific port set beforehand among the plurality of ports, a MAC address of the electronic device, wherein the relay unit carries out a communication through the wireless LAN interface using the obtained MAC address as a MAC address of the communication device.

The communication device employing the above-explained configuration obtains the MAC address of an electronic device connected to the specific port between the plurality of ports of the wired LAN interface, uses the obtained MAC address as the MAC address of the communication device, and communicates with the wireless device through the wireless LAN interface. When a support device that supports a protocol which is configured to instruct a predetermined operation to an electronic device having a MAC address of receiving communication packets based on information on the MAC address included in the body of the communication packets is connected to the specific port, the communication device starts communicating with the wireless device using the MAC address of the support device. Hence, the MAC address of the support device is grasped at a side of the wireless device, so that communication packets of that protocol can include the MAC address of the support device. As a result, when the communication device receives communication packets of that protocol from the wireless device and transfers the received communication packets to the support device, the support device can execute a predetermined operation based on the communication packets of that protocol.

In a case in which a connection with the wireless device is already established through the wireless LAN interface, when the MAC address is obtained, the relay device may cancel the connection and re-establishes a connection with the wireless device using the obtained MAC address.

The obtaining unit may obtain the MAC address based on an ARP request received through the wired LAN interface. The ARP request includes a Gratuitous ARP.

The specific port may be designed to be connected to a device that supports a protocol which is configured to instruct a predetermined operation to an electronic device having a MAC address of receiving communication packets based on information on the MAC address included in a body of the communication packets.

The protocol may be for realizing a Wake-On-LAN.

The wireless LAN interface may be communicatable with the wireless device as a non-access-point client.

[Newly Added]

The present invention is applied to a communication method of a communication device including a wireless LAN interface that can communicate with a wireless device other than the aforementioned communication device and a wired LAN interface having a plurality of ports. Particularly, the aforementioned communication method comprises the steps of relaying a communication between an electronic device connected to each of the plurality of ports in a communicatable manner and the wireless device through the wireless LAN interface and the wired LAN interface; and obtaining a MAC address of the electronic device when the electronic device is connected to a specific port set beforehand among the plurality of ports, wherein the MAC address thus obtained is used as a MAC address of the communication device when relaying a communication between the electronic device and the wireless device through the wireless LAN interface.

The present invention can be realized as, in addition to the above-explained communication device, a program used for a communication device, a recording medium storing that program, and a communication method, etc.

### BRIEF DESCRIPTION OF THE DRAWINGS

FIG. 1 is an explanatory diagram for an Ethernet converter according to an embodiment of the present invention;

FIG. 2 is an explanatory diagram for a general configuration of the Ethernet converter according to the embodiment;

FIG. 3 is a flowchart showing a flow of an address change process by the Ethernet converter according to the embodiment;

FIG. 4 is an explanatory diagram showing a specific example of a flow of a communication in the address change process and an activation process by the WOL according to the embodiment; and

FIG. 5 is an explanatory diagram showing a specific example of a flow of a communication in an activation process by the WOL according to a comparative example.

### DETAILED DESCRIPTION OF THE PREFERRED EMBODIMENT

An explanation will be given of an embodiment of the present invention with reference to the accompanying drawings.

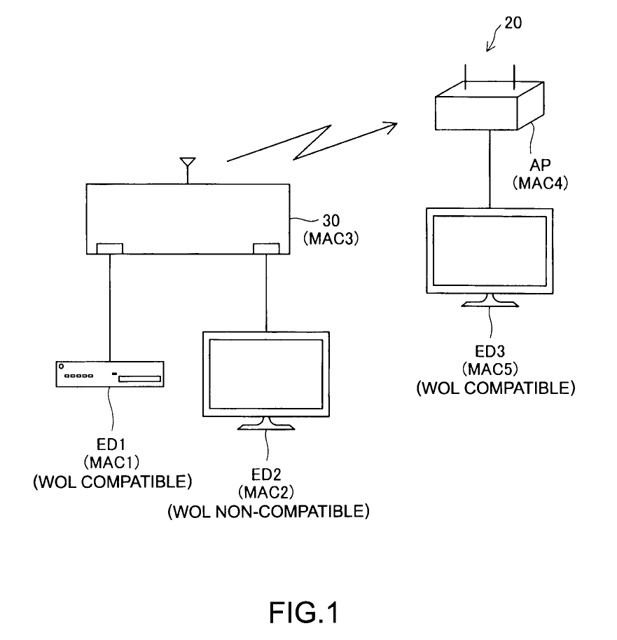

FIG. 1 shows an Ethernet converter 30 that is a communication device according to an embodiment of the present invention. FIG. 1 also shows a configuration of a home network 20 established for a home using the Ethernet converter 30. As shown in the figure, the home network 20 includes the Ethernet converter 30, an access point AP, and electronic devices ED1 to ED3.

The Ethernet converter 30 has a function as a station (a wireless terminal) and a bridge function that connects a wired LAN and a wireless LAN together. The Ethernet converter 30 has two wired ports that are connected to the electronic devices ED1 and ED2, respectively. The electronic device ED1 supports the WOL, and is an optical disk player according to the present embodiment. The electronic device ED2 is non-compatible with the WOL, and is a television according to the present embodiment. The electronic devices ED1 and ED2 have MAC addresses “MAC1” and “MAC2”, respectively, and the Ethernet converter 30 has a MAC address “MAC3” for a wireless communication interface.

The Ethernet converter 30 establishes a network with the access point AP based on a wireless LAN standard. The access point AP is a station (hereinafter, simply referred to as an “access point”) having an access point function in accordance with the wireless LAN standard, and has an access point function that relays a communication between stations, a bridge function of connecting the wired LAN and the wireless LAN together, and a DHCP (Dynamic Host Configuration Protocol) server function. The access point AP may have a router function, and may be connectable to an external network. The access point AP is connected to the electronic device ED3 through a wired LAN cable. The electronic device ED3 supports the WOL, and is a television according to the present embodiment. The access point AP has a MAC address “MAC4” and the electronic device ED3 has a MAC address “MAC5”, respectively. The electronic devices ED1 to ED3 can be various kinds of electronic devices, such as a personal computer, a PC-periphery device, an AV device, a telephone, and various home electronics.

Individual structural elements of the home network 20 can automatically detect a network device through UPnP (Universal Plug and Play), and can provide individual functions to one another. It will be discussed in detail later but in the home network 20, the electronic device ED1 can be activated using the WOL upon an operation to the electronic device ED3.

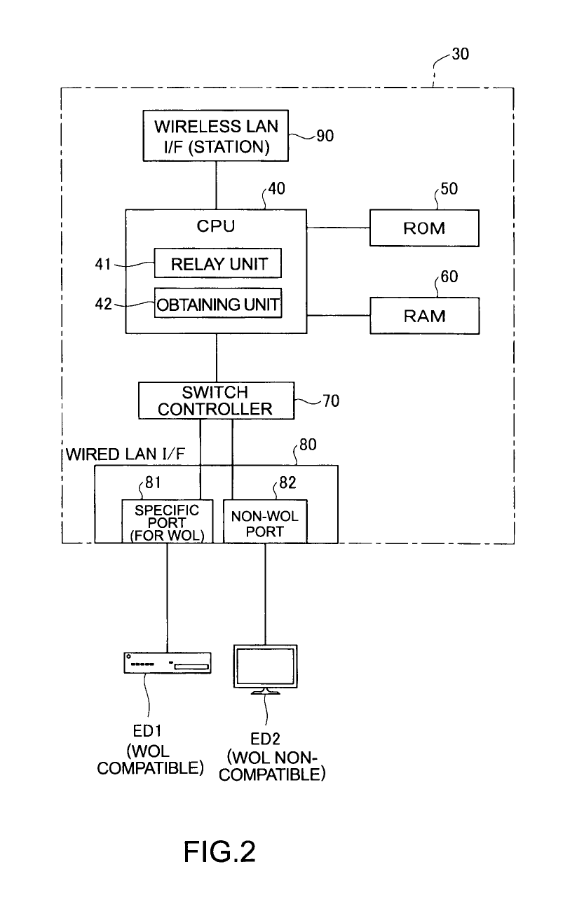

FIG. 2 shows a general configuration of the Ethernet converter 30. As shown in the figure, the Ethernet converter 30 includes a CPU 40, a ROM 50, a RAM 60, a controller 70, a wired LAN interface 80, and a wireless LAN interface 90, each of which is connected one another through a bus.

The controller 70 is a switch controller having a switching function, takes out a MAC frame from communication packets received, looks up an address table, and transmits the communication packets to a port corresponding to a destination MAC address. In this specification, a unit of data transfer for a communication is referred to as a “communication packet” regardless of a relationship with the layer of the OSI reference model.

The wired LAN interface 80 is for a connection to a wired LAN. In the present embodiment, the wired LAN interface 80 conforms to the IEEE (the Institute of Electrical and Electronics Engineers) 802.3 standard. The wired LAN interface 80 has two wired ports 81 and 82. The wired port 81 is designed beforehand to be connected to an electronic device that supports a protocol realizing the WOL, i.e., a protocol that enables an activation process through magic packets, and such a port is also referred to as a specific port 81. The wired port 82 is designed beforehand to be connected to an electronic device that does not support the protocol which realizes the WOL, and is referred to as a non-WOL port 82. In the home network 20, the electronic device ED1 that supports the WOL is connected to the specific port 81 and the electronic device ED2 that does not support the WOL is connected to the non-WOL port 82. The number of wired ports of the wired LAN interface 80 is not limited to two, and may be equal to or greater than three. In this case, the number of port to be connected to a device that supports the WOL, i.e., the specific port 81 is one.

The classification between the specific port 81 and the non-WOL port 82 is designed in order to be connected to a device that realizes the WOL through an address change process to be discussed later, and the specific port 81 and the non-WOL port 82 have the same structure. Hence, even if an electronic device not compatible with the WOL is connected to the specific port 81, a communication is enabled likewise a case in which such an electronic device is connected to the non-WOL port 82. If a message to the effect that the specific port 81 is designed to be connected to an electronic device that supports the WOL is indicated on the casing of the Ethernet converter 30 or is described in the manual of the Ethernet converter 30, a user can easily find out the kind of an electronic device to be connected to the specific port 81, and thus the user-friendliness improves. Regarding the non-WOL port 82, a message to the effect that it is designed to be connected to an electronic device not compatible with the WOL may be indicated.

The wireless LAN interface 90 serves as a station to be connected to a wireless LAN. In the present embodiment, the wireless LAN interface 90 conforms to the IEEE 802.11 standard.

The CPU 40 extracts a program like a firmware stored in the ROM 50 in the RAM 60 and runs such a program, thereby controlling the whole operation of the Ethernet converter 30. Moreover, the CPU 40 functions as a relay unit 41 and an obtaining unit 42 by running such a program. The relay unit 41 looks up the address table associating respective IP addresses of the electronic devices ED1 and ED2 with respective MAC addresses, and controls a relay operation of transferring communication packets received from the access point AP through the wireless LAN interface 90 to the electronic devices ED1 and ED2, respectively, through the wired LAN interface 80, and of transferring communication packets received from the electronic devices ED1 and ED2, respectively, through the wired LAN interface 80 to the access point AP through the wireless LAN interface 90.

When no electronic device is connected to the specific port 81, the relay unit 41 communicates with the access point AP using the local MAC address “MAC3”. For example, when receiving communication packets directed to the electronic device ED3 from the electronic device ED2 connected to the wired port 82, the relay unit 41 replaces the originator MAC address included in the communication packets from the MAC address “MAC2” of the electronic device ED2 to the MAC address “MAC3” of the Ethernet converter 30, and transmits the communication packets to the access point AP. When, on the other hand, an electronic device is connected to the specific port 81, a control different from the above explanation will be performed. The detail of such a control will be discussed later as the address change process. Moreover, in the present embodiment, when receiving communication packets with a destination IP address that is a broadcast address from the access point AP through the wireless LAN interface 90, the relay unit 41 is configured to transfer communication packets to the electronic devices ED1 and ED2, respectively, connected to the wired LAN interface 80. The obtaining unit 42 obtains, when an electronic device is connected to the specific port 81, the MAC address of that electronic device.

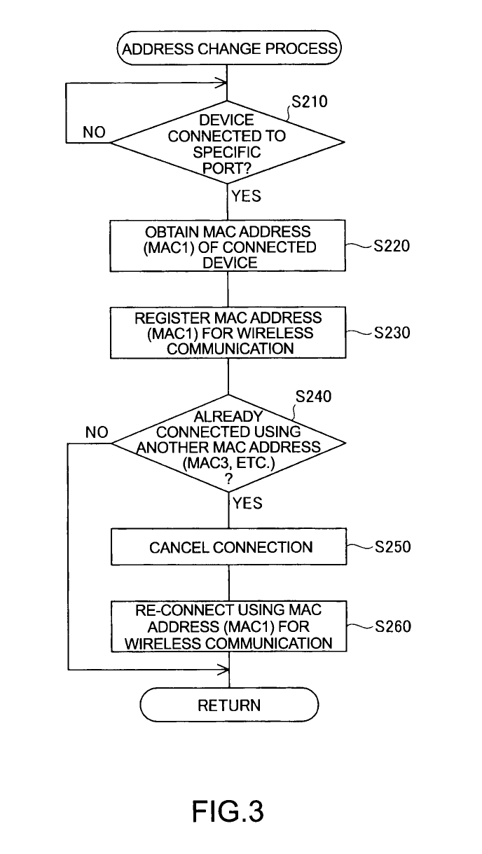

An explanation will be given of the address change process by the Ethernet converter 30. The address change process is executed by the Ethernet converter 30 changing a MAC address used in a communication through the wireless LAN interface 90 in order to realize the WOL over the home network 20. FIG. 3 shows a flow of the address change process. In the present embodiment, the address change process is started after the Ethernet converter 30 is powered on, and is repeatedly executed in parallel with a relay operation of communication packets.

As shown in FIG. 3, upon starting of the address change process, first, the CPU 40 of the Ethernet converter 30 stands by until detecting that an electronic device is connected to the specific port 81 (step S210). In the present embodiment, the Ethernet converter 30 is compatible with a tag VLAN (Virtual Local Area Network), and has a VLAN number set to be a predetermined number with the specific port 81 being as a tag port. Hence, the CPU 40 refers to tag information (a VLAN number) included in Gratuitous ARP when receiving the Gratuitous ARP, and is capable of determining that an electronic device is connected to the specific port 81 when a predetermined VLAN number is included. However, how to determine whether or not an electronic device is connected to the specific port 81 is not limited to any specific scheme, and for example, the CPU 40 may access the controller 70 on a regular basis, and may obtain link information of an electronic device to the specific port 81. It is possible to determine whether or not received communication packets are ARP packets by checking the type region of the communication packets. Moreover, it is also possible to determine whether or not the received ARP packets are Gratuitous ARP based on whether or not an originator IP address included in the ARP packets matches a target IP address. Gratuitous ARP is transmitted when an electronic device connected to the specific port 81 newly obtains an IP address, so that according to the above-explained scheme, it is possible to quickly determine whether or not an electronic device is newly connected to the specific port 81.

Next, when detecting that an electronic device is connected to the specific port 81 (step S210: YES), the CPU 40 serves as the obtaining unit 42 that obtains the MAC address of the electronic device connected to the specific port 81 (step S220). In the present embodiment, the electronic device ED1 is connected to the specific port 81, so that the MAC address obtained is “MAC1”. This process is configured to obtain an originator MAC address included in received Gratuitous ARP in the present embodiment.

When obtaining the MAC address “MAC1” of the electronic device ED, the CPU 40 registers obtained MAC1 as the MAC address for a wireless communication through the wireless LAN interface 90 (step S230). Thereafter, in a relay operation of the communication packets by the CPU 40 serving as the relay unit 41, the registered MAC1 is used as the local MAC address.

After registering MAC1, the CPU 40 determines whether or not a connection has been established with the access point AP (step S240). As a result, when a connection with the access point AP has not been established (step S240: NO), when a connection with the access point AP is thereafter established, MAC1 registered in the step S230 is used as the MAC address of the Ethernet converter 30, so that the CPU 40 terminates the address change process.

Conversely, when a connection with the access point AP has been established (step S240: YES), a connection with the access point AP is being established using a MAC address other than the MAC address registered in the step S230. For example, the Ethernet converter 30 is establishing a connection with the access point AP using the local MAC address MAC3. Alternatively, an electronic device other than the electronic device ED1 is connected to the specific port 81 before the electronic device ED1 is connected thereto, and a connection established using the MAC address of that electronic device is still maintained through the address change process executed previously. Hence, the CPU 40 once cancels the connection with the access point AP (step S250). Next, the CPU 40 uses MAC1 registered in the step S230 as the local MAC address, and re-establishes a connection with the access point AP (step S260).

Thus way, the address change process completes. When MAC1 is registered in this fashion, thereafter, when receiving communication packets transmitted to the access-point-AP side by the electronic devices ED1 and ED2, respectively, connected to the wired LAN interface 80, the MAC address “MAC1” registered in the step S230 is used as an originator MAC address, and the communication packets are transferred to the access point AP. Accordingly, a device at the access-point-AP side recognizes all originator MAC addresses of the communication packets received from the electronic devices ED1 and ED2, respectively, as MAC1. Conversely, when receiving communication packets transmitted from the access point AP to the electronic devices ED1 and ED2, respectively, although the destination MAC address included in the communication packets is MAC1, the CPU 40 checks the destination IP address included in the communication packets with the address table, and can transfer the communication packets to the electronic devices ED1 and ED2, respectively.

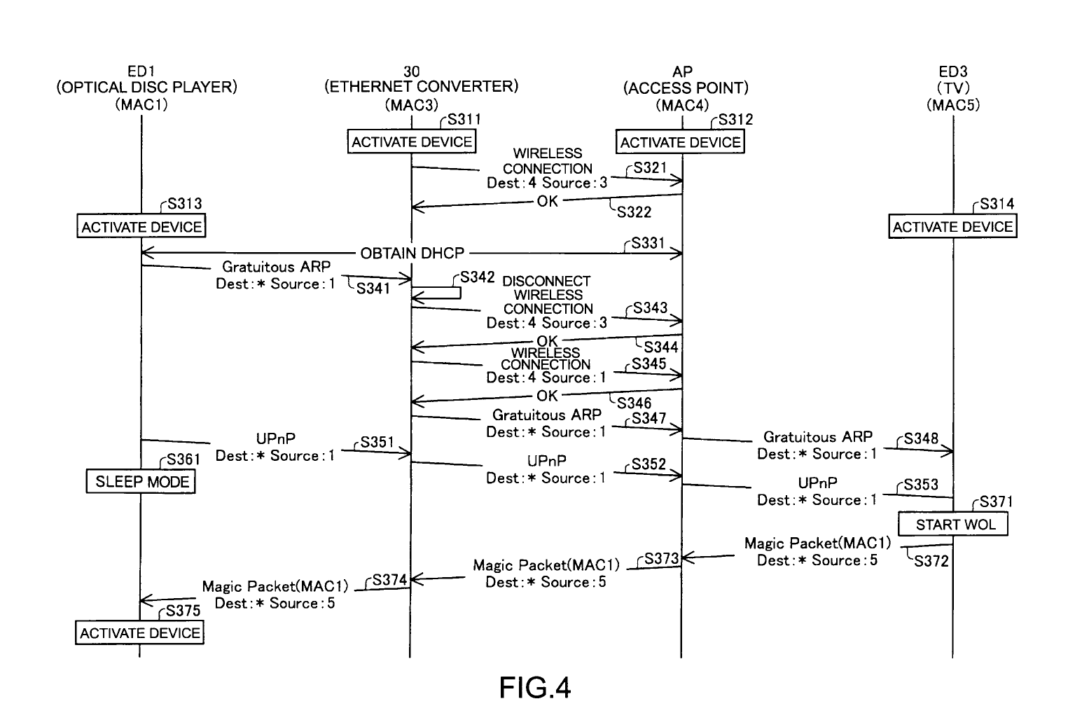

A flow of a communication in the home network 20 including the Ethernet converter 30 that executes the address change process and realizes the WOL will be explained with reference to a specific example shown in FIG. 4. In the following explanation, an explanation will be given of a flow of activating the electronic device ED1 through an operation to the electronic device ED3. As shown in the figure, when the Ethernet converter 30 is activated upon power-on (step S311), and the access point AP is activated upon power-on (step S312), the Ethernet converter 30 transmits an association request to the access point AP (step S321). Conversely, the access point AP transmits an association response to the Ethernet converter 30 (step S322). Accordingly, a wireless LAN connection is established between the Ethernet converter 30 and the access point AP.

Next, when the electronic device ED1 is activated upon power-on (step S313), the electronic device ED1 obtains an IP address through a DHCP discovery process that is executed with the access point AP having the DHCP server function (step S331). At this time, it is presumed that the electronic device ED3 is already activated upon power-on (step S314). The IP address may be obtained through Auto IP. Also, the IP address may be allocated in a fixed manner beforehand through a manual operation, etc. In this case, the access point AP need not to have the DHCP server function.

When obtaining the IP address, the electronic device ED1 broadcasts Gratuitous ARP in order to check the duplication of the IP address allocated to the electronic device ED1 itself. (step S341). The originator MAC address of Gratuitous ARP is MAC1.

When receiving Gratuitous ARP from the electronic device ED1, the Ethernet converter 30 registers MAC1 as a MAC address for a wireless communication based on the step S230 of the above-explained address change process (step S342). Next, the Ethernet converter 30 transmits disassociation request to the access point AP based on the step S250 of the above-explained address change process in order to request canceling of the connection (step S343). The originator MAC address of the disassociation request is MAC3 that is used when establishing the connection. Conversely, the access point AP receives the disassociation request, and cancels the connection with the Ethernet converter 30 (step S344).

When the connection with the access point AP is canceled, the Ethernet converter 30 uses MAC1 as the originator MAC address based on the step S260 of the above-explained address change process, transmits an association request to the access point AP (step S345), receives an association response from the access point AP (step S346), and re-establishes a connection. When the connection using MAC1 is established, the Ethernet converter 30 uses MAC1 registered in the step S230 as the local MAC address, and transfers received Gratuitous ARP to the access point AP (step S347). That is, the originator MAC address of Gratuitous ARP to be transferred remains as MAC1. As explained above, when a configuration of, after a connection is re-established, transferring Gratuitous ARP received before a connection is cancelled is employed, a duplication check of an IP address is ensured. When receiving Gratuitous ARP from the Ethernet converter 30, the access point AP transfers Gratuitous ARP to the electronic device ED3 (step S348).

The electronic device ED1 broadcasts a NOTIFY message to the effect of a participation of a device to the network based on UPnP (step S351). The Ethernet converter 30 receives the NOTIFY message, uses MAC1 registered in the step S230 as the local MAC address, i.e., with the originator MAC address remaining as MAC1, and transfers the NOTIFY message to the access point AP (step S352). When receiving the NOTIFY message, the access point AP transfers the NOTIFY message to the electronic device ED3 (step S353). Accordingly, the electronic device ED3 becomes able to recognize that the electronic device ED1 having the MAC address “MAC1” is connected to the home network 20. When a predetermined time has elapsed after transmitting the NOTIFY message, the electronic device ED1 becomes a sleep mode (step S361). The sleep mode is a mode in which power is supplied to at least the wireless LAN interface 90 in order to maintain a receivable state of magic packets to be discussed later, and an operation of the Ethernet converter 30 and a power supply thereto are restricted in order to reduce the power consumption.

When the NOTIFY message transmitted by the electronic device ED1 is received by the Ethernet converter 30 until the connection between the Ethernet converter 30 and the access point AP is once canceled through the steps S343 and S344 and those devices are re-connected again through the steps S345 and S346, such a NOTIFY message is not transferred to the access point AP. In this case, the electronic device ED3 can recognize the electronic device ED1 having the MAC address MAC through an M-SERCH message. More specifically, when the electronic device ED3 starts broadcasting the M-SERCH message, the Ethernet converter 30 receives the M-SERCH message through the access point AP. In the present embodiment, since the Ethernet converter 30 transfers broadcasted communication packets to the wired-LAN-interface-80 side, the electronic device ED1 can receive the M-SERCH message. Upon receiving of the M-SERCH message, the electronic device ED1 responds to the electronic device ED3. A response message is transferred by the Ethernet converter 30 with the originator MAC address remaining as MAC1 as explained above, so that the electronic device ED3 can recognize the electronic device ED1 having the MAC address MAC1. Likewise, when the electronic device ED3 is activated after the electronic device ED1 transmits the NOTIFY message, the electronic device ED3 can recognize the electronic device ED1 having the MAC address MAC1 through the same fashion.

When the electronic device ED3 recognizes the electronic device ED1 having the MAC address MAC1 as explained above, the electronic device ED3 becomes able to perform an activation process of the electronic device ED1 using the WOL. The activation process of the electronic device ED1 using the WOL is started when a user gives an activation instruction of the electronic device ED1 to the electronic device ED3 using the user interface thereof, e.g., a remote controller, and the electronic device ED3 receives such an instruction (step S371).

When receiving the activation instruction from the user, the electronic device ED3 generates magic packets, and broadcasts the generated magic packets (step S372). The body of the magic packets includes data having the MAC address “MAC1” of the electronic device ED1 repeated by sixteen times. The access point AP receives the magic packets transmitted from the electronic device ED3, transfers the received magic packets to the Ethernet converter 30 (step S373), and the Ethernet converter 30 receives the transferred magic packets and transfers the received magic packets to the electronic device ED1 (step S374).

The electronic device ED1 receives the magic packets transferred as explained above, and checks the body. Since the magic packets include the data having the MAC address “MAC1” of the electronic device ED1 repeated by sixteen times, the electronic device ED1 determines that the received magic packets include an instruction of activating the electronic device ED1 itself, and executes the activation process (step S375). Accordingly, the process of activating the electronic device ED1 through the electronic device ED3 using the WOL is realized.

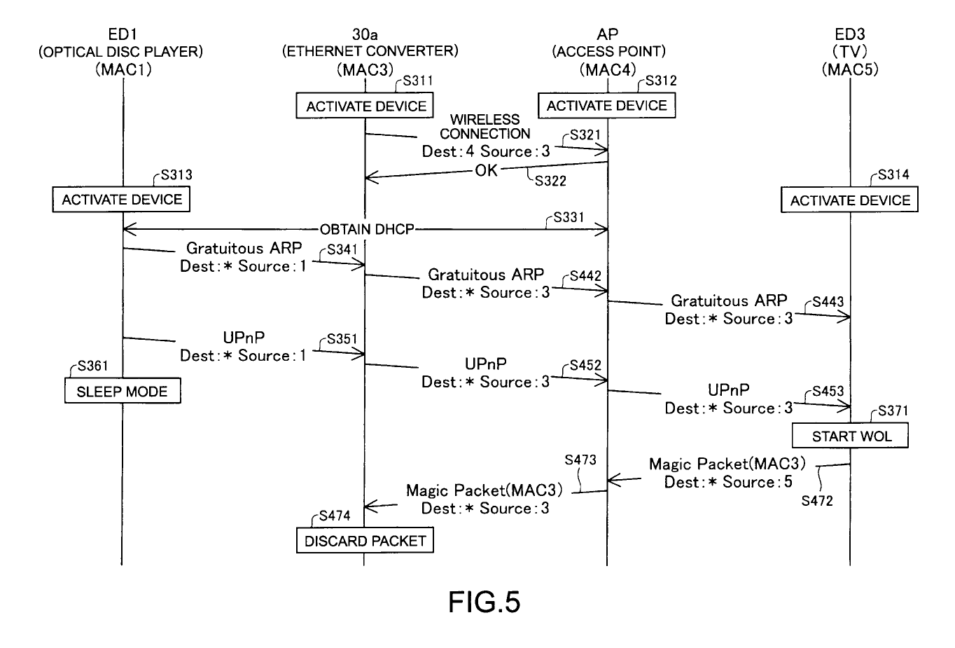

In order to clarify the advantage of the Ethernet converter 30, first, an explanation will be given of a flow of the activation process using the WOL when an Ethernet converter 30a of a prior art is used, and then the effect of the present embodiment will be explained. FIG. 5 shows a flow of the activation process using the WOL when the Ethernet converter 30a of the prior art is used. In FIG. 5, the same process flow as that of FIG. 4 will be denoted by the same reference numeral, and the duplicated explanation will be omitted or simplified below.

As shown in FIG. 5, when the electronic device ED1 obtains an IP address through a DHCP discovery process (step S331), and broadcasts Gratuitous ARP (step S341), the Ethernet converter 30a receives the broadcasted Gratuitous ARP, changes the originator MAC address from the MAC address “MAC1” of the electronic device ED1 to the local MAC address “MAC3”, and transfers the received Gratuitous ARP to the access point AP (step S442). The access point AP receives the Gratuitous ARP, and transfers the received Gratuitous ARP to the electronic device ED3 (step S443). Accordingly, the electronic device ED3 receives the Gratuitous ARP having the originator MAC address that is MAC3.

The electronic device ED1 broadcasts a NOTIFY message based on UPnP (step S351). The Ethernet converter 30a receives the broadcasted NOTIFY message, changes the originator MAC address thereof to the local MAC address “MAC3”, and transfers the NOTIFY message to the access point AP (step S452). The access point AP receives the NOTIFY message and transfers the received NOTIFY message to the electronic device ED3 (step S453). Accordingly, the electronic device ED3 recognizes that the electronic device ED1 having the MAC address of MAC3 is connected to the home network 20.

Next, when receiving an activation instruction for the electronic device ED1 given to the electronic device ED3 by a user (step S371), the electronic device ED3 generates magic packets, and broadcasts the generated magic packets (step S472). The body of the magic packets includes data having the MAC address “MAC3” recognized as the MAC address of the activation-target electronic device ED1 repeated by sixteen times. The magic packets transmitted by the electronic device ED3 are received by the access point AP and are transferred to the Ethernet converter 30a (step S473).

The Ethernet converter 30a that has received the magic packets discards the received magic packets since the broadcast address which is the destination IP address included in the magic packets is not registered in the address table (step S474). In this fashion, the magic packets transmitted by the electronic device ED3 are discarded by the Ethernet converter 30a and do not reach the electronic device ED1, so that activation of the electronic device ED1 is unsuccessful. If a configuration is employed which causes the Ethernet converter 30a to transfer communication packets having a destination IP address that is a broadcast address to the wired-LAN-interface-80 side, the electronic device ED1 can receive the magic packets. However, the MAC address representing the activation target and included in the received magic packets is “MAC3” that is the MAC address of the Ethernet converter 30a, so that the electronic device ED1 does not interpret the received magic packets and execute the activation process.

Conversely, the Ethernet converter 30 of the present embodiment obtains the MAC address of an electronic device connected to the specific port 81 between the plurality of wired ports 81 and 82 of the wired LAN interface 80, uses the obtained MAC address as the MAC address of the Ethernet converter 30, and communicates with the access point AP through the wireless LAN interface 90. When the electronic device ED1 that supports the protocol realizing the WOL is connected to the specific port 81, the Ethernet converter 30 communicates with the access point AP using the MAC address “MAC1” of the electronic device ED1. Accordingly, a device at the access-point-AP side, i.e., the electronic device ED3 can grasp the MAC address “MAC1” of the electronic device ED1, so that the electronic device ED3 can generate magic packets having the MAC address of the activation target that is the MAC address “MAC1” of the electronic device ED1, and broadcast the generated magic packets. The Ethernet converter 30 receives the magic packets through the access points AP, and transfers the received magic packets to the electronic device ED1. Accordingly, the electronic device ED1 receives the magic packets, interprets such packets, and executes the activation process based on the WOL.

Moreover, when the Ethernet converter 30 already establishes a connection with the access point AP at the time of obtaining the MAC address of the electronic device ED1 connected to the specific port 81, such a connection is once canceled and a connection is re-established using the obtained MAC address. Hence, even if the Ethernet converter 30 has already established a connection using the local MAC address, after the electronic device ED1 is connected to the specific port 81, a connection is changed to a new connection using the MAC address of the electronic device ED1, so that the electronic device ED3 can grasp the MAC address “MAC1” of the electronic device ED1 through a communication thereafter.

Moreover, the Ethernet converter 30 obtains the MAC address of the electronic device ED1 connected to the specific port 81 using Gratuitous ARP, so that the Ethernet converter 30 can easily obtain a MAC address using a general-purpose protocol. In addition, after the IP address is obtained through the DHCP, Gratuitous ARP is quickly transmitted by the electronic device ED1, so that the Ethernet converter 30 can quickly obtain the MAC address after the electronic device ED1 is connected to the specific port 81.

The detail of the communication device of the present invention is not limited to the above-explained embodiment, and can be changed and modified in various forms. For example, in the above-explained embodiment, the Ethernet converter 30 is configured to obtain the MAC address of the electronic device ED1 based on Gratuitous ARP. However, when receiving an ARP request from an electronic device connected to the specific port 81 in order to grasp the MAC address of the communication counterparty, the Ethernet converter 30 may obtain the MAC address of the connected device based on the ARP request. Such a configuration also facilitates the Ethernet converter 30 to obtain the MAC address.

The network configuration of the home network 20 is not limited to the above-explained embodiment, and can be a network having the Ethernet converter 30 allowed to wirelessly communicate. For example, the access point AP may be configured to relay communication packets from/to a plurality of stations, the electronic device ED3 may be connected to the Ethernet converter 30, and the access point AP may be configured to wirelessly communicate with the Ethernet converter 30. Alternatively, a configuration may be employed in which the electronic device ED3 is connected to the Ethernet converter 30 instead of the access point AP, and the Ethernet converter 30 realizes a wireless communication in an ad-hoc mode with another Ethernet converter.

In the above-explained embodiment, a configuration is employed in which it is detected that an electronic device is connected to the specific port 81 upon reception of Gratuitous ARP from the specific port 81. However, how to detect a connection of an electronic device to the specific port 81 is not limited to any particular scheme. For example, such a detection may be carried out based on a reception of DHCP discovery packets. Alternatively, by physically detecting a connection/disconnection of a cable to the specific port 81, a new connection of an electronic device may be detected. Furthermore, how to obtain the MAC address of an electronic device when such an electronic device is connected to the specific port 81 is also not limited to any particular scheme. For example, such a MAC address may be obtained through a predetermined application program, etc.

Moreover, in the above-explained embodiment, the distinction between the specific port 81 and the non-WOL port 82 is fixed, but such a distinction may be variable. That is, a wired port to be connected to an electronic device supporting the WOL among the plurality of wired ports of the wired LAN interface 80 may be selectable through a user interface. For example, a switch may be provided around the wired ports of the casing of the Ethernet converter 30, and the specific port 81 may be selected based on an operation given to the switch. Regarding such a switch, the same number of switches as that of the plurality of wired ports may be provided, and a switch stoppable at respective positions of the plurality of wired ports may be provided.

When the specific port 81 is selectable, the CPU 40 may detect a wired port selected as the specific port 81, obtain the MAC address of an electronic device connected to the detected wired port, and register the obtained MAC address in the step S230. According to this configuration, a user can select the specific port 81 after an electronic device is connected to each wired port of the wired LAN interface 80, so that the user-friendliness improves. For example, under a circumstance in which non-WOL-compatible electronic devices are connected to all wired ports, when one of the connected electronic devices is replaced with an electronic device that supports the WOL, it is appropriate if such an electronic device to be replaced is merely connected, resulting in the improvement of the user-friendliness.

Furthermore, according to the above-explained embodiment, the Ethernet converter 30 is configured to transfer communication packets to an electronic device connected to the wired LAN interface 80 when receiving such communication packets having a destination IP address that is a broadcast address from the access point AP. However, when no electronic device is connected to the specific port 81, received communication packets may be discarded. This reduces a process load of the electronic device connected to the wired LAN interface 80.

Still further, according to the above-explained embodiment, the explanation was given of a configuration in which the WOL is realized using the Ethernet converter 30. However, the Ethernet converter 30 can widely be applied to not only the WOL but also a case in which a remote operation is executed using a protocol that can instruct a predetermined operation to an electronic device that has a MAC address of receiving communication packets based on information on the MAC address included in the body of the communication packets. It is unnecessary that such a protocol is standardized.

What is claimed is:

1. A communication device comprising:
a wireless LAN interface that can communicate with a wireless device other than the communication device;
a wired LAN interface having a plurality of ports;
a relay unit that relays a communication between an electronic device connected to the plurality of ports in a communicatable manner and the wireless device through the wireless LAN interface and the wired LAN interface; and
an obtaining unit that obtains, when the electronic device is connected to a specific port set beforehand among the plurality of ports, a MAC address of the electronic device,
wherein the relay unit carries out a communication through the wireless LAN interface using the obtained MAC address as a MAC address of the communication device.

2. The communication device according to claim 1, wherein a connection with the wireless device is already established through the wireless LAN interface when the MAC address is obtained, the relay device cancels the connection and re-establishes a connection with the wireless device using the obtained MAC address.

3. The communication device according to claim 1, wherein the obtaining unit obtains the MAC address based on an ARP request received through the wired LAN interface.

4. The communication device according to claim 1, wherein the specific port is designed to be connected to a device that supports a protocol which is configured to instruct a predetermined operation to an electronic device having a MAC address of receiving communication packets based on information on the MAC address included in a body of the communication packets.

5. The communication device according to claim 4, wherein the protocol is for realizing a Wake-On-LAN.

6. The communication device according to claim 1, wherein the wireless LAN interface is communicatable with the wireless device as a non-access-point client.

7. A communication method of a communication device including a wireless LAN interface that can communicate with a wireless device other than said communication device and a wired LAN interface having a plurality of ports, comprising the steps of:
relaying a communication between an electronic device connected to each of the plurality of ports in a communicatable manner and the wireless device through the wireless LAN interface and the wired LAN interface; and
obtaining a MAC address of the electronic device when the electronic device is connected to a specific port set beforehand among the plurality of ports, wherein the MAC address thus obtained is used as a MAC address of the communication device when relaying a communication between the electronic device and the wireless device through the wireless LAN interface.
